(19) United States
(12) Patent Application Publication
(10) Pub. No.: US 2014/0214723 A1
(43) Pub. Date: Jul. 31, 2014

(54) METHOD AND SYSTEM FOR A PENSION FUNDING DERIVATIVE

(71) Applicant: United Services Automobile Association (USAA), San Antonio, TX (US)

(72) Inventor: Allen F. Jacobson, JR., San Antonio, TX (US)

(73) Assignee: United Services Automobile Association (USAA), San Antonio, TX (US)

(21) Appl. No.: 14/163,903

(22) Filed: Jan. 24, 2014

Related U.S. Application Data
(60) Provisional application No. 61/757,256, filed on Jan. 28, 2013.

(51) Int. Cl. G06Q 40/06

(52) U.S. Cl. CPC G06Q 40/06
USPC 705/36 R

(57) ABSTRACT

A system and method for developing a pension funding derivative, particularly wherein both interest rate changes and equity returns are taken into consideration so as to mitigate risk.

### CROSS REFERENCE TO RELATED APPLICATIONS

This application claims priority to U.S. Patent Application Ser. No. 61/757,256 filed Jan. 28, 2013 which is incorporated herein by reference in its entirety.

### FIELD OF THE INVENTION

The invention generally relates to a computer implemented method and system for designing a pension funding derivative.

### BACKGROUND OF THE INVENTION

Increases in the level of and variability in defined benefit pension plan costs have been a major concern for sponsors of such plans. Despite the shift from defined-benefit to defined-contribution plans, defined benefit plans still constitute an important portion of the financial landscape. According to the Federal Reserve Board, assets in private defined benefit plans amounted to $2.3 trillion as of the third quarter of 2012. Not only do these plans own significant assets, but also the liabilities owed by these plans to participants are often larger. According to a Milliman study of the funding level of the largest corporate pension plans in November 2012, the funded percentage (Assets in Pension Trusts/Plan Liabilities) was 74%. Plans sponsored by state and local governments have similar funding problems. The funding deficit for public plans has been estimated to be $700 billion according to an issue brief by the Congressional Budget Office. The same study indicated that using different methods and assumptions may increase that number to $2-3 trillion.

Two surveys of pension plan sponsors have indicated that the two primary economic drivers of pension concern are interest rates and return on assets. A 2010 survey of pension plan sponsors by Vanguard showed that interest rate and equity market risk were viewed as “very important” or “extremely important” by more sponsors than the other risks listed. Another survey of plan sponsors regarding risks to a pension plan cited interest rates and equity returns as two of the three most cited risks to a pension plan, with the third being longevity.

Since the turn of the millennium, poor returns on equities combined with decreasing interest rates have taken a toll on funding levels for defined benefit plans. The graph illustrated in FIG. 1 compares the annual S&P 500 total return on the X axis with the liability return for the illustrative pension plan used for the Citigroup Pension Liability Index on the Y axis. The Citigroup Pension Liability Index return measures the increase in the illustrative pension plan's liabilities over a year due to interest rate changes. As interest rates drop, the value of future benefits rises because those future payments are discounted less with the lower rates. This graph maps the increase in liabilities against equity returns from 1995 to 2011. Years plotted to the right and below the diagonal line indicate years in which equity returns were higher than the increase in liabilities. This should be a good outcome for many pension plans. Alternatively, those years to the left and above indicate years in which equity returns did not keep up with liability increases, which would indicate a poor result for many plans. Several of the years to the right were in the 1990s, during that decade's bull market. The years since 1999 have not been as favorable, with decreasing interest rates driving up the liabilities coupled with mediocre equity returns. It is to be appreciated that not only were those more recent years often tough on pension plans, but also some of them were very difficult as evidenced by the distance these years' points are from the diagonal line. This distance from the diagonal line indicates that liability increases far outpaced equity returns.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings.

One aspect of the present invention provides a method and system for designing a pension funding derivative that takes into consideration multiple factors, thereby mitigating risk. It is to be understood interest rate changes and volatile equity returns have contributed to significant funding and expense volatility for defined benefit plans in recent years. According to various embodiments, the present invention relates to the design of an option contract with payouts that are tied to the combined impact of interest rates and investment returns on the funding level of a defined benefit pension plan. Current derivatives used by plan sponsors are inadequate because they limit exposure to only a single risk. The present invention, on the other hand, provides a pension funding derivative designed so as to combine multiple risks, particularly by combining risks associated with both interest rates and investment returns. As a result, the pension funding derivative according to the present invention provides targeted protection to a plan sponsor at lower cost.

Another aspect of the invention relates to a computer-implemented method for processing and evaluating application data for a pension funding derivative in a computer processing system. The method includes the steps of: receiving application data relating to a pension fund, processing the application data contingent upon equity returns and interest rate returns for the pension fund, and determining a pension funding derivative based on the processed application data.

Additional objects and advantages of the invention will be set forth in part in the description which follows, and in part will be obvious from the description, or may be learned by practice of the invention. The objects and advantages of the invention will be realized and attained by means of the elements and combinations disclosed herein, including those pointed out in the appended claims. It is to be understood that both the foregoing general description and the following detailed description are exemplary and explanatory only and are not restrictive of the invention as claimed. The accompanying drawings, which are incorporated in and constitute a part of this specification, illustrate several embodiments of the invention and, together with the description, serve to explain the principles of the invention.

### BRIEF DESCRIPTION OF THE DRAWINGS

The accompanying appendices and/or drawings illustrate various non-limiting, example, inventive aspects in accordance with the present disclosure:

FIG. 1 is a graph showing equity return vs. liability return for an illustrative pension plan for the years 1996 through 2011;

FIG. 2 illustrates a system overview and data-flow of an illustrative embodiment that may be used with the present invention;

FIG. 3 is a graph showing a visual display of the benefit stream of a sample plan according to an embodiment of the present invention;

FIG. 4 is a block diagram illustrating a general overview of a funding derivative determination system, according to an embodiment of the present invention;

FIG. 5 is a graph showing funding status based on the combination of equity returns and interest rate changes according to an embodiment of the present invention;

FIG. 6 is a graph showing the benefits and fixed-income cash flows of a sample plan according to an embodiment of the present invention;

FIG. 7 is a graph that plots each scenario's error amount against the change in the interest rate index for that scenario according to an embodiment of the present invention;

FIG. 8 illustrates deficit distributions using the three investment strategies: the sample plan, variation 1 and variation 2 according to an embodiment of the present invention; and

FIG. 9 is a flow diagram in accordance with an embodiment of the present invention.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The term “time period” means any increment of time appropriate for a pension plan and derivative in question. For example, some suitable time periods can include a month or year.

The term “origination date” means the date the contract comes into existence and the date from which the original asset positions and liabilities of the pension plan are calculated

The term “expiration date” means the date the derivative ceases to exist and the date from which the calculation of any payoffs from contract ownership are calculated.

The term “funding deficit” means the value of pension liabilities less the market value of investments as of a particular point in time.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

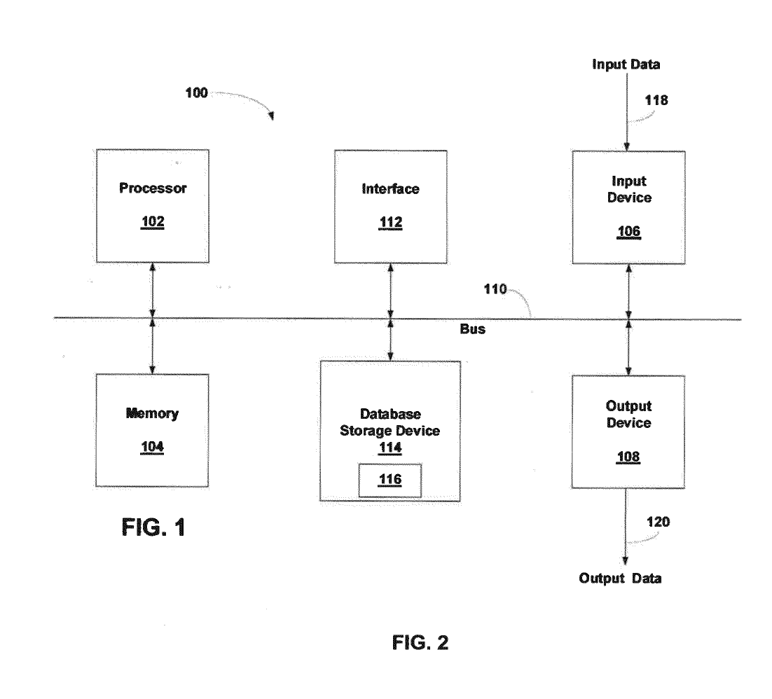

Turning now descriptively to the drawings, in which similar reference characters denote similar elements throughout the several views, FIG. 2 depicts an exemplary general-purpose computing system in which illustrated embodiments of the present invention may be implemented.

A generalized computering embodiment in which the present invention can be realized is depicted in FIG. 2 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 2 may operate in a networked environment using logical connections to one or more remote computers. The remote computer may be a personal computer, a server, a router, a network PC, a peer device, or other common network node, and typically includes many or all of the elements described above.

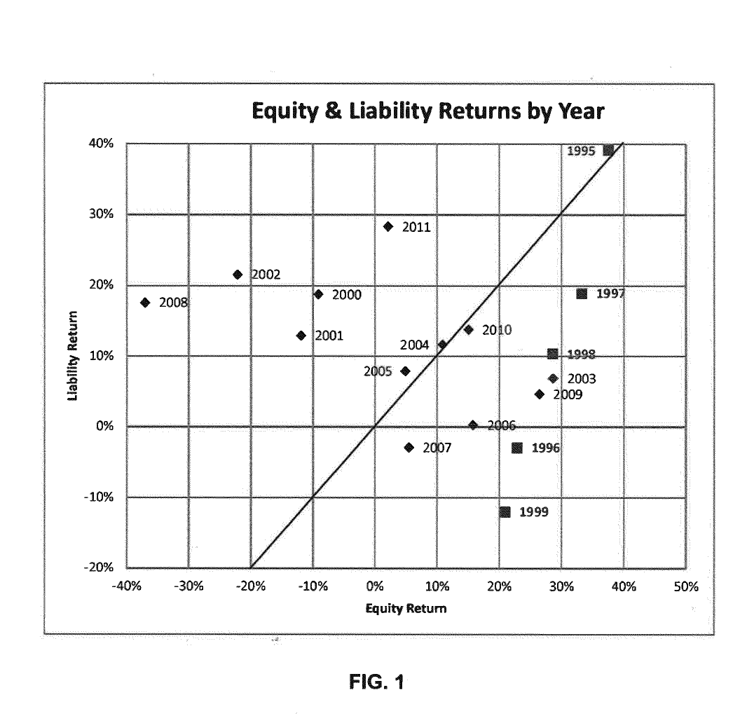

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 2 are exemplary and other means of establishing a communications link between multiple computers may be used.

FIG. 2 is intended to provide a brief, general description of an illustrative and/or suitable exemplary environment in which embodiments of the below described present invention may be implemented. FIG. 2 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 2. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, tablet devices, smart phone devices, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

It is to be appreciated that an aspect of this invention relates to the potential for a derivative that, if owned by a plan or sponsor, could alleviate some or all of the impact of such years. The derivative is designed to limit the impact of these two drivers on pension funding status.

In accordance with an illustrated embodiment, development of the derivative in accordance with an embodiment of the invention may be achieved in the follow steps:
Describe a pension plan whose funding status we wish to protect;
Decide on the metric we are attempting to control;
Develop an index of the chosen metric that can be used to calculate payoffs;
Discuss the basic design of the derivative;
Estimate a price for the derivative;
Discuss how well the new derivative manages the funding risk for the plan; and
Simulate how well the derivative works for plans that differ from the sample plan.

### Sample Pension Plan

In developing a derivative that targets the combination of interest rate and equity moves that cause a pension plan financial stress, preferably a plan is defined for which is being managed. Through this plan, which is also referred to as the sample plan, calculated are the impact of changes in these two financial variables.

It is to be appreciated defined benefit pension plans can differ in many ways, including the benefits offered, plan participant characteristics, funding status, and investment policy. Despite these differences, many plans have two fundamental characteristics. First, they are exposed to significant interest rate risk because the duration of the benefit liability is much longer than the fixed-income investments owned by the plan. It is also often the case that the liabilities are also larger than the fixed-income portfolio, which exacerbates the interest rate risk due to dollar duration exposure. The second common characteristic is that the plans own significant assets other than fixed-income securities. These can be equities, real estate, or alternative investments. Ideally, the value of these assets will grow more quickly than the liabilities do over time. However, short-term volatility between the liability measure and the value of these assets is common. This leads to volatility in plan funding and costs. The subject illustrated sample plan exhibits these two characteristics.

Below Table 2 describes several of the main attributes of the plan and why those attributes are chosen.

TABLE 2
Sample Plan Attributes

| Attribute | Rational for Choice |
|---|---|
| Benefits | Pension professionals would describe this plan as |
| are no longer | “frozen.” Many plans are now in this state. |
| accruing | Once a plan is frozen, the primary drivers of the |
| | plan are financial rather than human resource |
| | concerns. By using a frozen plan, we avoid changes |
| | in the benefit stream due to accruals over time. |
| Benefits are | We chose this benefit pattern over lump sum designs, |
| calculated and | such as cash balance plans, to lengthen the benefit |
| paid as life | stream and increase interest rate risk. Most plans |
| annuities | are either designed with life annuity benefits or have |
| | a material legacy liability with these types of benefits. |
| The plan is | As discussed in the first section, many plans are |
| underfunded | underfunded. Our sample plan exhibits this characteristic. |
| The plan has | Plans often have a large portion of their investments |
| significant | in assets other than fixed-income investments. |
| equity | |
| investments | |

Now that some of the main plan design and investment parameters have been illustrated, a determination is made of the participant group and benefits so that the plan's benefits can be projected. The participant group is preferably composed of both retirees collecting benefits and active and terminated vested participants with deferred benefits. Statistics for the participant group can be found in below Table 3.

TABLE 3
Sample Plan Participant Statistics

| | | Average | Average Annual |
|---|---|---|---|
| | Count | Age | Accured Benefits |
| Participants with | 794 | 44.2 | $10,738 |
| deferred benefits | | | |
| Retired participants | 390 | 72.7 | $11,318 |
| in payout status | | | |
| Total Participants | 1,184 | 53.7 | $10,929 |

It is noted accrued benefits were adjusted to groups by age for active and deferred vested participants using a reasonable progression of average service, as older workers would generally have more service. Pension benefits for older retirees are assumed to be smaller than those of younger retirees, as there is no cost of living adjustment and their benefits were determined years earlier and not adjusted for inflation since that time.

Actuarial assumptions regarding mortality and interest rates are listed in below Table 4. The benefit levels were scaled so that the actuarial liability for the plan using these assumptions would come to $100 million at the beginning of the year. This enable simplified scaling of the derivative to a particular plan's size.

TABLE 4
Valuation Assumptions

| Initial Valuation Date | Dec. 31, 2010 |
|---|---|
| Initial Interest Rates | Citigroup Pension Liability Curve Rates as of |
| | December 2010 |
| Mortality Assumptions | IRS Notice 2008-85 2010 Static Mortality^{VII} |
| | Ages 61 and Under: Non Annuitant Mortality |
| | Rates |
| | Ages 62 and Over: Annuitant Mortality Rates |
| Male/Female Mix | 50%/50% |

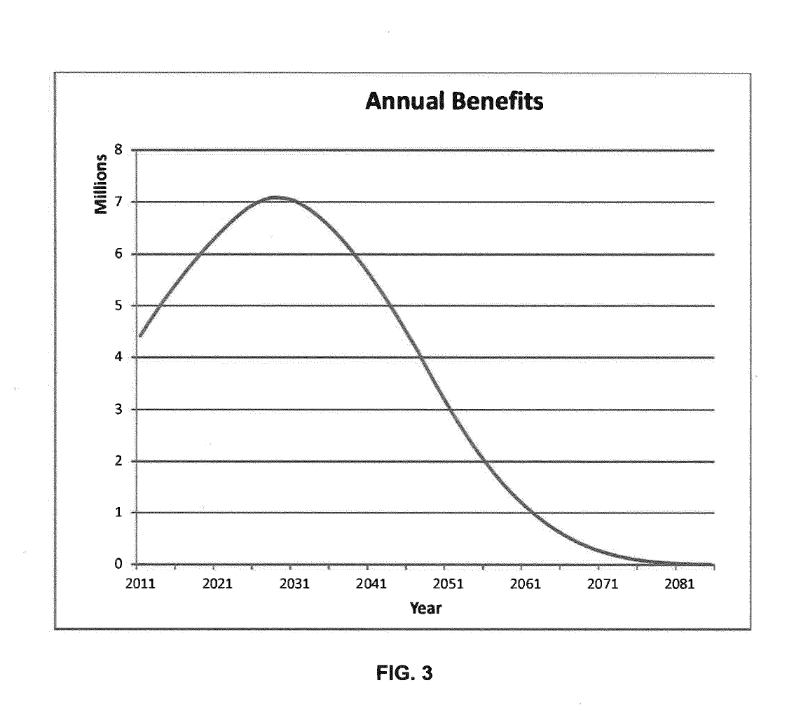

A visual display of the benefit stream is shown in FIG. 3. As illustrated in the graph, the plan has significant benefits due further out than 30 years—a situation that is common in defined benefit pension plans. The sample plan is assumed to be 80% funded, so there is an initial funding deficit of $20 million. The initial allocation of investments is 60% equities and 40% fixed income. This was often a traditional asset allocation for pension plans. The fixed-income portfolio includes cash and short-term investments that cover the first year of benefit payments of approximately $4.4 million. The rest of the fixed-income portfolio was built to cover 32% of the benefit payments in years 2 through 30. This fixed-income allocation was chosen so that the plan has adequate short-term liquidity while stretching the remaining assets to the 30-year window that is investable in taxable bonds. The balance sheet for the sample plan and the Macaulay duration statistics are shown in Table 5.

TABLE 5
Beginning Balance Sheet for Sample Pension Plan

| | Amount | Macaulay Duration |
|---|---|---|
| Liabilities | $100,000,000 | 13.7 |
| Assets: | | |
| Equities | $48,000,000 | |
| Fixed Income | $32,000,000 | 7.1 (Including First Year Cash), |
| | | 12.1 (Bond Cash Flows Years 2-30) |
| Total Assets | $80,000,000 | |
| Funding | ($20,000,000) | 15.2 (Benefit less the Bond |
| Surplus/(Deficit) | | Net Cash Flows) |

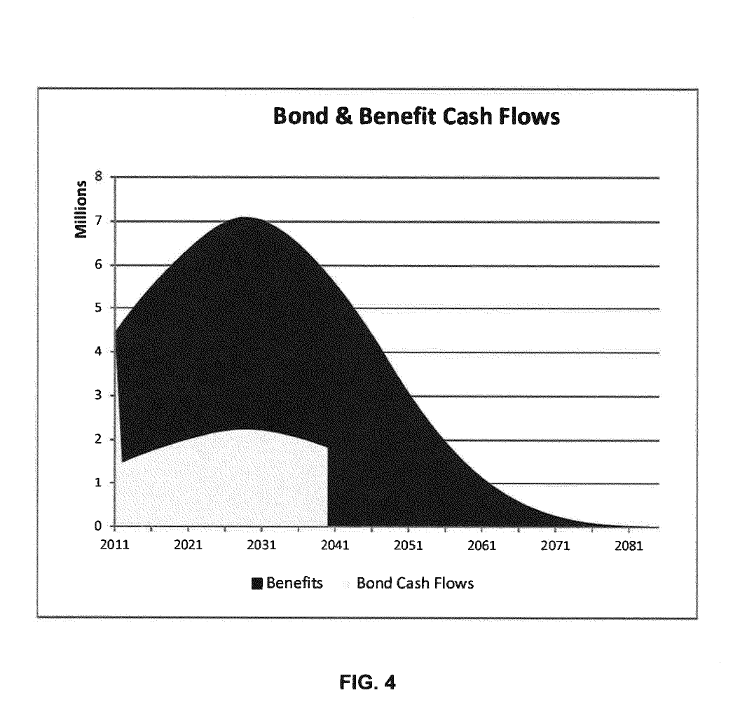

It is to be appreciated the funding duration is calculated by examining the liability cash flows not covered by the fixed-income cash flows. The benefits and fixed-income cash flows are shown in FIG. 4. All cash flows are modeled as occurring at mid-year so the last fixed income cash flow is mid-year of 2040 and none after that point.

### Determining the Metric to Manage

It is noted financial risk to a pension plan sponsor can materialize in several ways: cash contributions can rise, income statement costs can rise, the balance sheet impact can reduce sponsor net worth, or the plan's funded status could be adversely impacted. There is often a strong causality relationship between these effects that makes them occur at the same time. In determining a metric to manage by way of the derivative, we considered each of these impacts.

The use of a cash contribution or income statement metric posed several challenges. The main issue is that the rules for determining these impacts varied significantly by plan type and sponsor. The cash contribution rules for government, union, and private employer plans are all different. Cash contributions can also be influenced by elections made in prior years that do not directly reflect the financial health of the plan. There are similar differences between plan sponsors for income statement impact. Another concern was that the year-by-year change in these two metrics may either be positively or negatively leveraged to the actual change in the plan's financial status.

Also taken into consideration is the funded status as a percentage of plan liabilities. Funded status percentage, which is defined as the value of the plan's assets as a percentage of plan liabilities, is often used as a measure of plan funding health. It is also often a contributing factor in determining cash contributions. However, this measure is not preferable because a plan can have the same funded status percentage from one point in time to the next, and the sponsor may have absorbed a loss, for example, if a plan begins the year with $1 billion in plan liabilities and $800 million in assets and ends the year with $1.1 billion and $880 million in assets. The funded percentage has stayed 80%; however, the dollar funding deficit has grown from $200 million to $220 million. It is assumed sponsors would not view this as a breakeven proposition.

Therefore the metric of the actual raw dollar deficits is preferably used for the sample plan. It is understood that, by targeting that metric directly, the actual impact to the sponsor can be more closely tracked of the two risks attempted to be managed. The dollar deficit often contributes to cash contribution and income statement impacts, as well as any balance sheet recognition. It also allows the sponsor to directly tie the management of the deficit size to the sponsor's economic size and resources. The one item it may not manage as well is the funding percentage in the rising interest rate environments. However, this risk can be more manageable, because rising interest rates reduce the risk that funding deficits will grow to an unmanageable size.

### Visualizing and Disclosing Risk

It is to be understood one way to look at a sponsor's risk tolerance is to determine how much of a change in the pension deficit (in terms of dollars) would cause financial strain for the sponsor. Although funding contributions generally lag the emergence of an increase in the deficit, rising deficits are a good indicator of higher future cash contributions. Increased deficits can lead to higher reported expense and balance sheet impacts and, if severe enough, can cause challenges to the plan sponsor to raise capital. The derivative developed here is designed to attack the dollar amount of the deficit directly. By using this as a measure of the index and therefore the payout of the derivative, the owner of the derivative can limit the changes in the dollar amount of underfunding to an amount that is manageable to that plan sponsor.

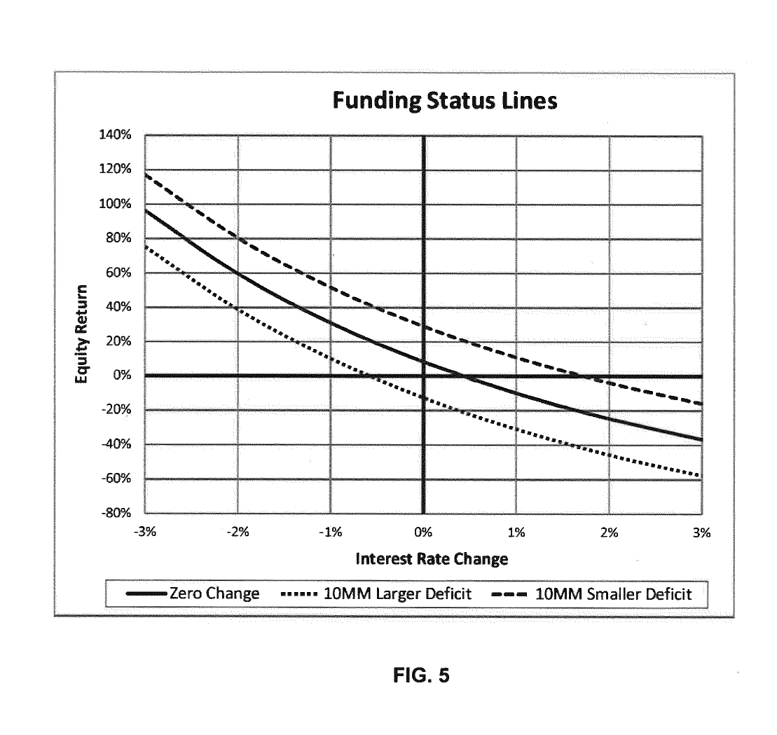

One way to appreciate the impact of equity returns and interest rates on a pension plan is to map funding levels one year out against the ending interest rates and equity return combinations that would generate that deficit size. FIG. 5 illustrates the combination of these items that produces no change in the deficit as well as either a $10 million increase or decrease in the funded status whereby interest rate changes are parallel shifts in the yield curve (with a floor of 1 basis point for certain down shifts). The graph of FIG. 5 provides illustration of what various changes in the two economic outcomes would have on funding status. To develop this graph, the pension actuary can estimate the impact of interest rate changes on plan liabilities, and the fixed-income manager could estimate the impact of interest rate changes on that portfolio. Finally, the equity return impact is just algebra. These impacts could be combined into a graph, like FIG. 5. Currently, public companies with defined benefit plans generally disclose a sensitivity test of the discount rate for liabilities and expected rate of return on pension expense. These impacts are described in terms of the impact they would have had on expense for the most recent past year the impact or the liability disclosed at the last balance sheet date.

It is to be appreciated the information of FIG. 5 enables a reader to get a sense for how exposed a plan is to these risks. The graph combines the impacts of these risk drivers instead of dealing with each one on its own. It is also forward looking to what might happen over the next year instead of how historical information would have changed. The reader can also estimate the impact of his or her own expectations of equity returns and interest rate changes on the plan's deficit amount. A similar graph could be developed for pension expense.

### Simulating What Might Happen

To obtain feedback on the effectiveness of the derivative to manage risk and to find a way to price the derivative, it is desirable to use a model that would develop multiple scenarios of future interest rates and equity returns. A source for such scenarios is the economic scenario generator from the Society of Actuaries and the American Academy of Actuaries. This generator takes an initial set of treasury interest rates and generates scenarios of what might happen to interest rates as well as various types of investment funds. A generator is used to develop 1,000 scenarios of spot treasury rates after one year as well as returns on an S&P index fund over the year.

The model generates treasury rates at several key points on the yield curve. Because AA spot rates were needed similar to those in the Citigroup Pension Discount Curve for discounting both plan liabilities and bond cash flows, the treasury spot rates at December 2010 for the treasury bonds were compared to the spot rates for AA bonds in the Citigroup data as of December 2010. Based on the difference in rates a spread was developed above the treasuries at each spot rate. Added to that spread to the appropriate modeled spot rate for each scenario. To develop the full spot yield curve, a linearly interpolation was used between each key rate to get a full set of spot rates. This approach causes all variability in rates to be due to the changes in treasury rates.

This work developed a full set of AA interest rates and an equity return for each of 1,000 scenarios. The statistics for these scenarios can be found in the tables below. Table 6 below provides statistics for these modeled scenarios. It is clear from the statistics that the simulator, on average, produced flatter yield curves than the initial curve by raising the short-term rates while lowering the longer-term rates.

TABLE 6
Statistics for Interest Rate and Equity Return Simulator

| | | Simulated AA Rates One Year Out | | |
|---|---|---|---|---|
| | Equity Returns | 1 Year Spot | 10 Year Spot | 30 Year Spot |
| Initial Rate | N/A | 1.04% | 4.77% | 5.88% |
| Maximum | 59.9% | 4.20% | 6.46% | 6.92% |
| 99.5% | 55.1% | 3.75% | 6.17% | 6.83% |
| 99.0% | 52.1% | 3.41% | 6.07% | 6.69% |
| 75.0% | 18.7% | 2.07% | 5.04% | 5.67% |
| 50.0% | 8.30% | 1.57% | 4.75% | 5.38% |
| 25.0% | −1.70% | 1.12% | 4.47% | 5.11% |
| 1.0% | −28.4% | 0.76% | 3.89% | 4.42% |
| 0.5% | −30.8% | 0.76% | 3.83% | 4.32% |
| Minimum | −55.3% | 0.76% | 3.63% | 4.12% |

### Derivative Design

Three aspects of the derivative design are preferably to be considered. First, how long should the life of the derivative be? Second, what type of derivative should be used? Finally, how should the index be developed on which the derivative is based?

The optimal life span of the derivative does not have a clear answer. Pension plans are long-term entities. The eventual cost of the plan to the sponsor is determined by the long-term experience of the plan. Therefore, long-lived options probably have a place in this environment. However, for this analysis, we designed and priced an option with a term of one year. The one-year term options have significant advantages over longer-term options.

First, the one-year term coincides with the financial disclosure period of many sponsors. By holding the term of the option to the same period as the financial disclosure period, sponsors can target the exact amount of risk they are willing to take between financial statements. They can then buy a contract that very closely matches their needs and know that the payoff or valuation will closely match those needs. Secondly, by limiting the term to one year, the market may be deeper, because suppliers and speculators do not tie themselves to long-term commitments. Different pension plans will have different long terms risk management needs, but many could use short-term protection as part of their risk management. They could regularly buy the one-year derivatives as they are needed. By using these shorter instruments, sponsors can adjust their purchases from year to year to reflect changing funding levels, investment policies, and risk tolerances. Finally, owning a one-year option limits that credit risk of the sponsor to the counterparty to just the one year.

The second derivative design issue is what type of derivative to design. The use of an option was chosen. The option allows the sponsor to determine how much tail risk to mitigate based in its needs and the costs. An option also allows the sponsor to keep all the upside potential of an unhedged position less the cost of the option. Sponsors who have decided to own significant stakes of equities or other non-fixed-income investments in their plans have usually done so because they expect those investments to outpace liability increases over time. An option design enables these sponsors to continue with that fundamental strategy while reducing the downside risk. Finally, an option is easier to understand than some more exotic derivative designs, an attribute which may increase its adoption rate.

It is assumed that the option would be European in design. That design allows for exercise at contract expiration. Allowing early exercise may present a challenge as some of the inputs to the index formula may not be constantly available. Lack of such inputs may make calculating early exercise payoffs difficult or impossible.

### Development of the Index

In order to develop the index upon which the option payouts are based, several pieces of information are preferably needed. First what is needed to be known is the plan design and investments for which the index is developed. Secondly, the type of changes to the risk drivers need to be determined such that the index matches the outcomes.

The sample plan described above is utilized to develop the index. One thing to note with regard to interest rate moves is what set of cash flows are being used to measure the interest rate index. Because a frozen plan is assumed, no new benefits are being added during the year. Therefore, the benefits projected for each subsequent calendar year at year end are the same as projected for that calendar year at the beginning of the year. Also, the first year of benefits are paid out of fixed-income assets.

The Citigroup curve is developed using liability-only cash flows. That is appropriate for that index, as that index is a liability measure. Because the impact on funding status for the index are being measured, the impact on both liabilities and assets are measured. Therefore, in developing the interest rate index, the net cash flows (benefits paid—fixed income cash flows) are utilized in each projected year.

The index is calculated using two methods. First, the actual results are calculated at various equity returns and parallel shifts in the yield curve. In the down shifts, if the shift forced the simulated rates to zero or negative, the rate is floored at that term to 1 basis point. So in the larger down shifts, the moves are not exactly parallel. An index formula is then defined that simulates the funded status at these test points.

It is to be appreciated, the method utilized calculated the funded status at each of the 1,000 simulations for interest rates and equity returns, as discussed above. The index function should be a function of the equity return and interest rate measure since the equity return is known in each simulation.

To determine the interest rate index, the level interest rate is calculated that develops the same funded status on the interest rate side as the full yield curve simulated for that scenario. The index rate is also calculated that developed the same liability amount net of bond values at the beginning of the year. That rate was 5.447% as of December 2010. The interest rate index change was the index rate from each simulation less the starting index rate of 5.447%. With the deficit amount, equity return, and interest rate index change for each simulation, a formula is developed that closely estimates the funding status for each simulation. The method includes determining how do equity returns change the funded status? This was determined be adjusting the funding status by the dollar exposure to the equities multiplied by the total return in the year. Interest rate change was determined via a quadratic formula based on interest rate changes. It is noted that by adding a cubic term to the function, a good fit to the actual results was achieved. Finally, the constant was set so the error terms centered around zero. The formula developed is shown below.

Dₜ=1,000,00(−0.13 l³+1.223 l²−48 E+23.701)

### Where:

Dₜ=Funding deficit at year end
l=interest rate index change in year (5% Expressed as 5.0)
E=Equity return in year (5% Expressed as 0.05)

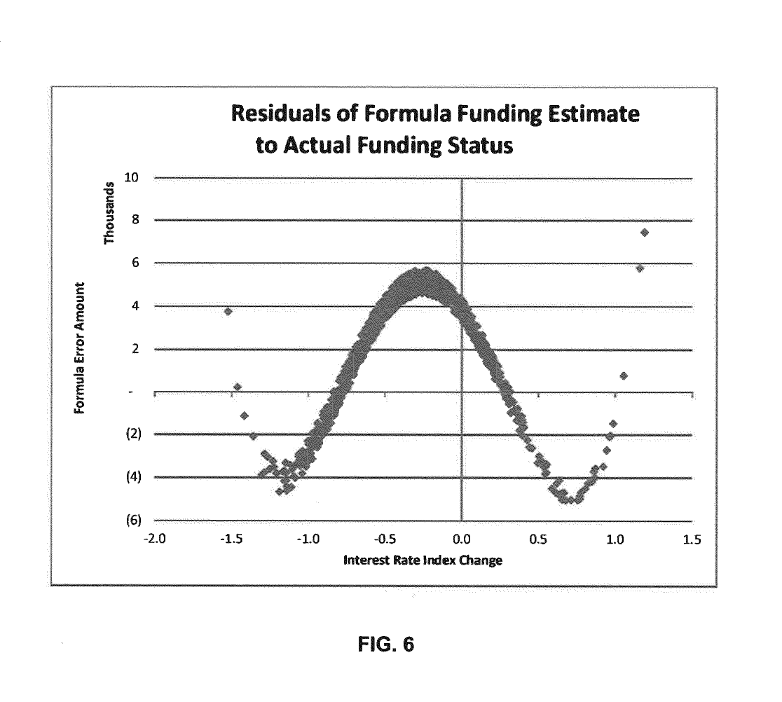

It is noted the error terms in this process are all within approximately $6,000, which is quite reasonable for an index measured in the tens of millions. They do exhibit a pattern as shown in FIG. 6, which plots each scenario's error amount against the change in the interest rate index for that scenario. It is noted that one issue with using this method to determine the formula is that the sample only contains interest rate changes of 150 basis points in either direction from the initial index rate.

With the move, though slow, to liability-driven investing in pension plans, a question is raised as to why the option designed here has significant equity exposure and shorter-term bond investments. It is noted that a number of plans have exposures similar to the sample plan here. This option may not meet the needs of all plans, but it could assist in the risk management of a large number of plans.

Utilizing this formula, the price of and the payoff from the option is developed. Once the price of the option at various strike prices is determined, the effectiveness of owning the option on deficit variability relative to the cost of the strategy is analyzed.

### Pricing the Option

To price the option here at a given strike price, the results from the 1,000 scenarios are preferably utilized. The payoff, if any, is calculated at the end of the year for each scenario. That payoff back at the AA 1 year rate assumed at the beginning of the projection is then discounted. Instead of discounting the payoffs at the risk-free rate, the AA rate was used. This allows for pricing in some counterparty credit risk to the option owner. If some credit enhancement is available, such as a centralized exchange with margin requirements, a lower discount rate may be appropriate. This generated the present value of the payoff for each scenario. To calculate the value of the option, the average payoff present value over the 1,000 scenarios is determined. The advantage of this method is that it is an objective measure of the option price on an expected-value basis. Using this method also says that, on an expected value basis, the sponsor is indifferent between buying the option or not. It does, however, change the distribution of the results at the end of the year.

It is assumed that the sponsor would buy the option outside of plan assets. By buying the option with outside funds, investment allocation within the plan is unaffected. The resulting deficits shown in the analysis below reflect the actual plan deficit, any payoff from the option, and the premiums of the option with interest on the option at the AA rate for the year. If there is a payoff, the sponsor would have those funds available to contribute to the plan if so desired. If the sponsor would purchase the option with plan assets, the sponsor would need to determine which initial assets to sell to pay for the option. This change in investments would require a slightly different index formula.

Using the method described above, the premium required for the option as well as the distribution of the funding deficits is calculated, reflecting the premium paid for the option. With reference to below table 7, the right-hand column shows the results had no option been purchased.

TABLE 7
Funding Results at Various Option Strategies

| | Strike Price | | | | |
|---|---|---|---|---|---|
| | 10 | 20 | 30 | 40 | No Option |
| | Million | Million | Million | Million | Purchased |
| (Financial Results | | | | | |
| in $ MM) | | | | | |
| Option Preimum | 13.5 | 5.6 | 1.2 | 0.1 | N/A |
| Scenarios with a | 912 | 656 | 229 | 31 | N/A |
| Payoff (out of 1,000) | | | | | |
| Statistics for Ending | | | | | |
| Deficit (Reflecting | | | | | |
| Price Of Option) | | | | | |
| Maximum | 23.7 | 25.7 | 31.2 | 40.1 | 59.4 |
| 99.50% | 23.7 | 25.6 | 31.2 | 40.1 | 48.4 |
| 99% | 23.7 | 25.6 | 31.2 | 40.1 | 44.4 |
| 73% | 23.7 | 25.6 | 30.6 | 29.5 | 29.4 |
| 50% | 23.7 | 25.6 | 25.2 | 24.1 | 24.0 |
| 25% | 23.7 | 23.0 | 18.5 | 17.4 | 17.3 |
| 1% | 15.3 | 7.3 | 2.9 | 1.8 | 1.7 |
| 0.50% | 10.9 | 2.9 | (1.6) | (2.6) | (2.8) |
| Minimum | 7.4 | (0.7) | (5.1) | (6.2) | (6.3) |

### Impact of the Option

Ownership of the option has two preferable clear impacts. First, it does reduce the volatility of results. Adverse outcomes cannot get worse than a maximum ending deficit, which is a function of the strike price and the premium for the option. The sponsor can decide how much adverse risk they are willing to take by selecting an option with an appropriate strike price. Secondly in the median and better scenarios, a plan sponsor is better off not owning the option. The cost of the option is weighing down results when the results are better than the strike price. The optimal strategy for a plan sponsor is thus dictated by the sponsor's risk tolerance and the actual option prices in the marketplace. However, it is noticeable that more than one percent of the scenarios without option ownership have ending deficits greater than $40 million. That is twice the initial deficit. Although 1% is a small chance, it is not impossible. According to these calculations, an option which could effectively cut off the risk beyond that point can be purchased for $0.1 million.

### Sensitivity Testing

It is to be appreciated the option constructed above was designed with a particular plan in mind. Although it shares many primary characteristics with a large number of pension plans, it is reasonable to wonder how well a derivative based on the index formula would mitigate the risk for a plan with different specifications. To answer this, two sensitivity tests are performed by separately making two changes to the sample plan.
Variation 1: This plan has the all the same specifications as the sample plan, except the bond investments are shorter in duration. This exposes the plan to larger interest rate risk, particularly to the long end of the curve. To shorten the duration, the bond cash flows is changed to match exactly the benefit cash flows for the first 6 years and 98% of the cash flow in the 7th year. The present value of those cash flows is still $32 million. However, now the duration of bond cash flows after the first year has shortened from 12.1 years to 4.0 years. The duration of the net cash flows (benefits minus bonds) has lengthened from 15.2 years to 20.0 years. The option payoffs are still based on the index formula developed using the sample plan. Below table 8 illustrates a comparison of the statistics for owning the option at various points compared to the unprotected position.

TABLE 8
Funding Results for Variation 1

| | Strike Price | | | | |
|---|---|---|---|---|---|
| | 10 | 20 | 30 | 40 | No Option |
| | Million | Million | Million | Million | Purchased |
| (Financial Results | | | | | |
| in $ MM) | | | | | |
| Option Premium | 13.5 | 5.6 | 1.2 | 0.1 | N/A |
| Scenarios with a | 912 | 656 | 229 | 31 | N/A |
| Payoff (out of 1,000) | | | | | |
| Statistics for Ending | | | | | |
| Deficit (Reflecting | | | | | |
| Price of Option) | | | | | |
| Maximum | 29.1 | 31.1 | 36.6 | 45.0 | 64.3 |
| 99.50% | 28.5 | 30.4 | 36.0 | 44.6 | 52.3 |
| 99% | 28.2 | 30.2 | 35.7 | 43.8 | 47.9 |
| 75% | 26.3 | 28.2 | 32.5 | 32.0 | 31.9 |
| 50% | 25.6 | 27.3 | 27.1 | 26.1 | 25.9 |
| 25% | 24.8 | 24.5 | 20.1 | 19.1 | 18.9 |
| 1% | 15.5 | 7.4 | 3.0 | 1.9 | 1.8 |
| 0.50% | 10.9 | 2.8 | (1.6) | (2.7) | (2.8) |
| Minimum | 7.8 | (0.2) | (4.7) | (5.7) | (5.9) |

Variation 2: Again, this plan has all of the same specifications as the sample plan, except that the investment mix is 40% equity and 60% bonds. By changing this mix, the plan's exposure to equity investments is reduced and also reduced is the exposure to interest rates because of the higher fixed-income investment. The fixed-income investments are invested similarly to the sample plan's portfolio. There is sufficient cash and short-term paper to cover the first-year benefits. The remainder is invested to cover a pro rata share of benefit payments for years 2 through 30. In the sample plan, that pro rata share was 32%. With the higher fixed-income allocation, we can now cover 50%. Results of option ownership to this plan are shown in below table 9.

TABLE 9
Funding Results for Variation 2

| | Strike Price | | | | |
|---|---|---|---|---|---|
| | 10 | 20 | 30 | 40 | No Option |
| | Million | Million | Million | Million | Purchased |
| (Financial Results | | | | | |
| in $ MM) | | | | | |
| Option Premium | 13.5 | 5.6 | 1.2 | 0.1 | N/A |
| Scenarios with a | 912 | 656 | 229 | 31 | N/A |
| Payoff (out of 1,000) | | | | | |
| Statistics for Ending | | | | | |
| Deficit (Reflecting | | | | | |
| Price of Option) | | | | | |
| Maximum | 29.5 | 27.6 | 30.4 | 35.9 | 49.4 |
| 99.50% | 28.2 | 27.4 | 30.1 | 35.2 | 41.3 |
| 99% | 28.1 | 27.1 | 29.8 | 35.0 | 38.4 |
| 75% | 25.1 | 25.3 | 27.4 | 27.8 | 27.7 |
| 50% | 23.4 | 24.0 | 24.8 | 23.8 | 23.7 |
| 25% | 21.8 | 22.1 | 20.3 | 19.2 | 19.1 |
| 1% | 17.3 | 13.3 | 8.8 | 7.8 | 7.7 |
| 0.50% | 16.3 | 10.2 | 5.8 | 4.7 | 4.6 |
| Minimum | 13.7 | 8.1 | 3.7 | 2.6 | 2.5 |

As indicated in the above results, the option still provides significant risk management in the most extreme scenarios. It may be possible to provide bespoke options to sponsors based on a particular plan's risk profile; however, a deeper market may develop if a standardized option that meets most sponsors' needs can be developed.

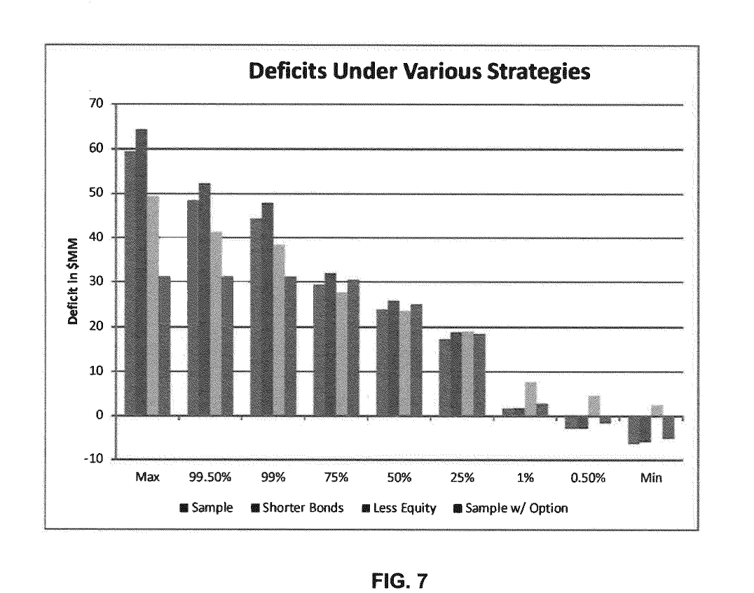

With reference now to FIG. 7, compared is the deficit distributions using the three investment strategies (sample, variation 1 and variation 2) with the outcomes for sample plan assuming ownership of the deficit funding option with a $30 million strike price. As expected, the option strategy performs well is stressed scenarios. Noted is how little is lost in the advantageous scenarios. By adopting the reduced equity strategy, risk is reduced, but not as much as the option strategy. The reduced equity strategy outperforms the option strategy in the median to moderately adverse outcomes, but at the risk of much larger deficits at more adverse outcomes. This comparison indicates the development of such an option may be very advantageous to plan sponsors.

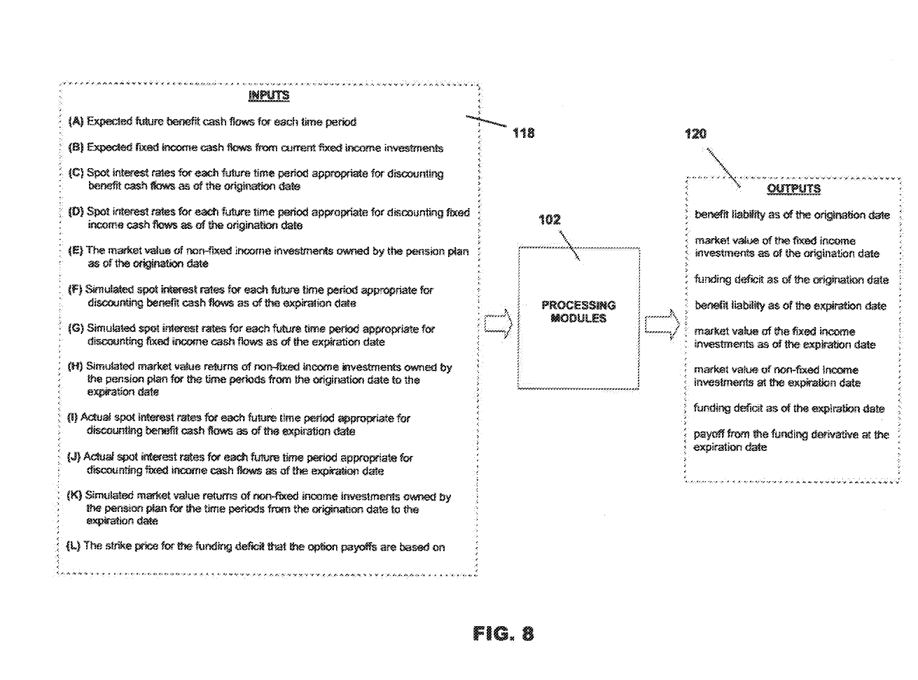

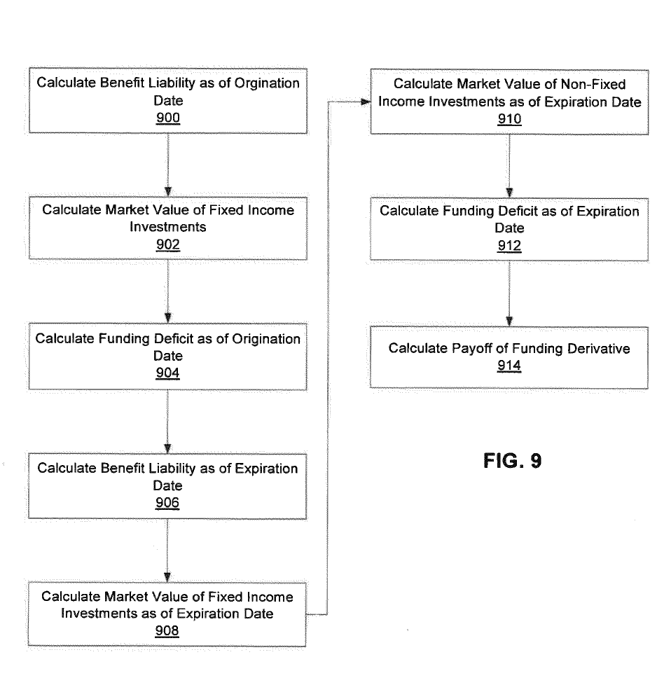

With an illustrated embodiment of the invention described above, a method of operation preferably utilizing system 100 (FIG. 2) is now described and illustrated with reference to FIGS. 8 and 9.

Starting at step 900, the benefit liability as of the Origination Date is calculated using the benefits payment from expected future benefit cash flows from each time period (input A) and the spot interest rates for each future Time Period appropriate for discounting benefit cash flows as of the Origination Date (input C). Next at step 902, the market value of the fixed income investments as of the Origination Date is calculated using the fixed Income cash flows from the spot interest rates for each future Time Period appropriate for discounting benefit cash flows as of the Origination Date (input D) and the interest rates from the spot interest rates for each future Time Period appropriate for discounting fixed income cash flows as of the Origination Date.

At step 904, the Funding deficit as of the Origination Date is calculated using the results of steps 900 and 920, and the market value of non-fixed income investments owned by the pension plan as of the Origination Date (input E). At next step 906, using the benefit payments from Input Item A past the Expiration Date and the interest rates from the actual spot interest rates for each future Time Period appropriate for discounting benefit cash flows as of the Expiration Date (input I), the benefit liability as of the Expiration Date is calculated. Next, at step 908, using the fixed Income cash flows from Input Item C. past the Expiration Date and the interest rates from the actual spot interest rates for each future Time Period appropriate for discounting fixed income cash flows as of the Expiration Date (input J), the market value of the fixed income investments as of the Expiration Date is calculated.

At step 910, the Market Value of Non-Fixed Income investments at the expiration date as the Market Value of Investments as of the Origination Date plus the returns on these assets is calculated using the simulated market value returns of non-fixed income investments owned by the pension plan for the time periods from the Origination Date to the Expiration Date (input K) less the benefit payments from Origination Date to Expiration Date plus the Fixed Income Cash Flows from Origination Date to Expiration Date. Next at step 912, the Funding Deficit as of the Expiration Date is determined which is equal to calculated benefit liability (step 906) minus the calculated market value of fixed income investments (step 908), minus the calculated market value of non-fixed income investments (step 910).

Finally at step 914, the payoff from the funding derivative at Expiration Date is determined which is equal to the determined funding deficit as of the Expiration Date (step 912) minus the strike price for the funding deficit that the option price is based on (input L), but not less than zero.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention and of the manner and process of making and using it in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A computer-implemented method for designing a pension funding derivative, said method comprising the steps of:
defining a pension fund;
receiving application data relating to the pension fund;
determining a plurality of risk factors for the pension fund;
processing the application data taking into account the plurality of risk factors;
and determining a pension funding derivative based on the processed application data.

2. The computer-implemented method according to claim 1, wherein the step of processing the application data includes the steps of:
calculating a benefit liability as of an origination date of the pension fund;
calculating a market value of fixed income investments as of the origination date of the pension fund;
calculating a funding deficit as of the origination date of the pension fund;
calculating a benefit liability as of an expiration date of the pension fund;
calculating a market value of the fixed income investments as of the expiration date of the pension fund;
calculating a market value of non-fixed income investments at the expiration date of the pension fund;
calculating a funding deficit as of the expiration date of the pension fund; and
calculating a payoff from a funding derivative at the expiration date of the pension fund.

3. An apparatus for designing a pension funding derivative comprising:
a memory configured to store instructions;
a processor disposed in communication with said memory, wherein said processor upon execution of the instructions is configured to
provide input data with respect to a sample pension fund;
determine a plurality of risk factors for the sample pension fund;
processing the input data taking into account the plurality of risk factors; and
determine a pension funding derivative based on the processed input data.

4. A computer program product comprising a computer useable medium having control logic stored therein for causing a computer to design a pension funding derivative, said control logic comprising:
first computer readable program code for causing the computer to receive application data relating to a defined pension fund;
second computer readable program code for causing the computer to determine a plurality of risk factors for the defined pension fund;
third computer readable program code for causing the computer to process the application data taking into account the plurality of risk factors; and
fourth computer readable program code for causing the computer to determine a pension funding derivative based on the processed application data.
